(19) United States
(12) Patent Application Publication
(10) Pub. No.: US 2024/0012736 A1
(43) Pub. Date: Jan. 11, 2024

(54) REAL-TIME APPLICATION LOG COLLECTION AND LOG ANALYTICS USING A SINGLE RUNTIME ENTRY-POINT

(71) Applicant: VMWARE, INC., Palo Alto, CA (US)

(72) Inventors: SHASHIKIRAN SINGARAPU, Palo Alto, CA (US); GAURAV SAWHNEY, Bangalore (IN); AMIT AGARWALA, Bangalore (IN); RAHUL DINESH SHETTY, Bangalore (IN); CHITWAN KAUDAN, Palo Alto, CA (US)

(21) Appl. No.: 17/940,201

(22) Filed: Sep. 8, 2022

(30) Foreign Application Priority Data
Jul. 9, 2022 (IN) 202241039552

(51) Int. Cl. G06F 11/36

(52) U.S. Cl. CPC G06F 11/3612

(57) ABSTRACT

The disclosure provides a method for of analyzing logs generated by one or more applications developed based on different programming languages and frameworks. The method generally includes calling, by a wrapper script, the one or more applications for execution, capturing, by the wrapper script, output from the one or more applications as logs in a first log file, and analyzing, by the wrapper script, the logs to determine one or more actions to take.

### RELATED APPLICATIONS

Benefit is claimed under 35 U.S.C. 119(a)-(d) to Foreign Application Serial No. 202241039552 filed in India entitled “REAL-TIME APPLICATION LOG COLLECTION AND LOG ANALYTICS USING A SINGLE RUNTIME ENTRY-POINT”, on Jul. 9, 2022, by VMware, Inc., which is herein incorporated in its entirety by reference for all purposes.

### BACKGROUND

Virtualization is a process whereby software is used to create an abstraction layer over computer hardware that allows the hardware elements of a single computer to be distributed among multiple virtual computers. In certain cases, the software used is called a hypervisor—a small layer that enables multiple operating systems (OSs) to run alongside each other, sharing the same physical computing resources. When a hypervisor is used on a physical server (also known as a bare metal server or a host) in a data center, the hypervisor allows the physical computer to decouple OS and applications from the hardware thereby enabling the creation and management of virtual machines (VMs). The result is that each VM contains a guest OS, a virtual set of hardware resources that the OS requires to run, and an application and its associated libraries and dependencies. Other types of virtual computing instances (VCIs) may also be used similarly as VMs.

While virtualization enables running multiple OSs on the hardware of a single physical server, containerization, on the other hand, enables deploying multiple applications using the same OS on a single VM or server. In particular, containerization is the packaging of software code with just the OS libraries and dependencies required to run the code to create a single lightweight executable, referred to as a container, which runs consistently on any infrastructure. Containers simplify delivery of distributed applications, and have become increasingly popular as organizations shift to cloud-native development and hybrid multi-cloud environments.

Containers encapsulate an application as a single executable package of software that bundles application code together with all of the related configuration files, libraries, and dependencies required for the application to run. The application may be any software program, such as a word processing program, or a “microservice” that encapsulates logic for an application that is distributed across multiple containers, virtual machines, virtual functions, and/or other systems. Application code and libraries may be developed separately for each application.

In some cases, application code and libraries may be developed to allow for data logging. Data logging, e.g., the process of collecting and storing data over a period of time in order to analyze specific trends or record data-based events/actions of an application, is an important aspect of software development. Information logged for an application may contain a wealth of information about one or more events associated with the application. Such information may be used, for example, for troubleshooting issues, creating alerts, identifying problems, and/or performing regular checks with respect to the application. In some cases, logs from multiple applications running in an environment (e.g., a multi-cloud environment) may be analyzed for analysis and monitoring purposes within the environment.

This form of data logging may involve developers manually inserting code into their applications. Given the plurality of different programming languages and frameworks which may be used today for writing different applications, a centralized application logging mechanism (e.g., a cloud-based logging mechanism) may not be feasible to enable such logging and log management for multiple different applications. Thus, each application developer may be responsible for selecting a specific logging mechanism (or library) for each application and configuring each application to use the specific logging mechanism. Accordingly, a selected logging mechanism may become tightly coupled with application logic defined for each application. The logging mechanism configured for each application may follow certain logging strategies to record application events as log entries.

Further, in some cases, an application developer may also be responsible for configuring each application with logic to perform real-time log analytics and monitoring, where such analytics and monitoring are desired. In some other cases, analytics and monitoring may occur at an external log analytics platform. Accordingly, an application developer may be responsible for configuring each application with code for streaming logs output by an application into the log analytics platform for real-time log analytics and monitoring of one or more applications in the environment, including the application.

Accordingly, the responsibility bestowed on an application developer to enable such logging and/or log management and analysis of logs for different applications in an environment, such as a multi-cloud environment, may be significant.

### SUMMARY

A method of analyzing logs generated by one or more applications developed based on different programming languages and frameworks is provided. The method includes: calling, by a wrapper script, the one or more applications for execution, capturing, by the wrapper script, output from the one or more applications as logs in a first log file, and analyzing, by the wrapper script, the logs to determine one or more actions to take.

Further embodiments include a non-transitory computer-readable storage medium storing instructions that, when executed by a computer system, cause the computer system to perform the method set forth above. Further embodiments include a computing system comprising at least one memory and at least one processor configured to perform the method set forth above.

### BRIEF DESCRIPTION OF THE DRAWINGS

FIG. 1 depicts example physical and virtual components in a networking environment in which embodiments of the present disclosure may be implemented.

FIG. 2 is a flow diagram illustrating example operations for capturing application logs using a single runtime entry-point, according to an example embodiment of the present disclosure.

FIG. 3 is a flow diagram illustrating example operations for local log analytics and monitoring, according to an example embodiment of the present disclosure.

FIG. 4 is a flow diagram illustrating example operations for summarizing log information prior to transmission of such information to an external log analytics platform for analysis, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure introduces a single runtime entry-point for application execution and log collection. An entry-point refers to a point where execution begins. More specifically, the entry-point to an application that is compiled as an executable file (e.g., code, script, etc.) is where execution of the file formally starts. The entry-point described herein may be a wrapper. In certain implementations, a wrapper may be a shell script that embeds one or more application commands or utilities. A wrapper “wraps around” existing script(s) and/or command line(s), thereby creating a single point of entry for controlling, invoking, and/or manipulating such script(s) and/or command line(s). Though certain aspects are described with respect to scripts or applications as executables, any suitable executables may be used to implement the techniques herein.

As used herein, a script generally refers to a combined set of instructions that, when executed, perform various functions in association with a computing system that they are executed on. The functions performed may include, for example, launching applications. In some cases, a script may comprise a file that includes multiple instructions. When executed, each instruction is interpreted by an operating system (OS) in which it is executed.

The wrapper described herein may be used to control the execution of one or more applications. For example, scripts and instructions for one or more applications running on containers in a multi-cloud environment may be scheduled and executed through a wrapper. Though certain aspects are described with respect to a container-based system in a multi-cloud environment, the techniques described herein may similarly be used with any suitable system (e.g., virtual machine (VM)-based system, computer-based system, etc.) of any suitable computing environment.

The wrapper may invoke the execution of one or more applications using some form of a system call. Execution of the one or more applications involves reading and acting on the instructions associated with each of the applications. As a computing machine follows the instructions, specific effects are produced in accordance with the semantics of those instructions. Further, the output from executing such instructions may be produced in two separate streams: standard out (stdout) and standard error (stderr). The stdout stream is where a script's main's output goes. For instance, the command “1s” is responsible for listing the files and directories within a file system, and this listing is directed to stdout. On the other hand, the stderr stream is where debugging information and errors may be directed to. The stderr stream may include errors, as well as runtime information. Though certain aspects are described with respect to capturing output from streams such as stdout and stderr, the techniques described herein may be used to capture any suitable output associated with execution of one or more applications.

According to aspects described herein, the wrapper may be further used to capture output from stderr and stdout streams as logs and write the logs in a log file of a log file path. For example, the wrapper may capture outputs from stdout and stderr streams by piping the output at real-time using a 0-length input buffer pipe. In certain aspects, the wrapper may be used to capture user-selected output as logs (e.g., a user may customize what information is to be captured, by the wrapper, as logs). In certain aspects, the log file path where logs of an application are written may be local to a container or other computing machine that is executing that application. The container or other computing machine may be configured with one or more ingestion agents which are responsible for collecting logs written in the log file path and forwarding these logs to an external log analytics platform for analysis.

As a result of using the wrapper, log management (e.g., log collection, analysis, and reporting) may be decoupled from application logic. In particular, an application developer may be responsible for inserting code into applications needed for streaming and writing output logs to an OS window (e.g., Windows console). However, the application developer may not be concerned with log management of such logs, as the log collection and transmission of logs for analysis may be handled by the wrapper (e.g., decoupled from application code) and one or more ingestion agents. As such, the burden placed on a developer to implement logging mechanisms may be lessened.

Further, in certain aspects, use of the wrapper may allow for local application monitoring and observability in the multi-cloud environment. Monitoring may provide a limited view of application data focused on individual metrics. This approach is sufficient when applications' failure modes are well understood. Accordingly, monitoring may be helpful when it is understood how an application fails, but as applications in an environment become more complex, so do the failure modes. For example, in conventional environments, monitoring tools may use dashboards to show performance metrics and usage, which may be used to identify or troubleshoot issues. However, because such dashboards are static and created by a user of the dashboard, the dashboards may only reveal performance issues or abnormalities the user is able to anticipate. This may make it difficult to monitor complex cloud-native applications and cloud environments for security and performance issues, where the security issues encountered may be multi-faceted and unpredictable.

By contrast, observability is the ability to understand an environment's internal state by analyzing the data it generates, such as logs, metrics, and traces. Observability infrastructure may be used to measure all the inputs and outputs across multiple components such as applications, microservices, programs, servers, and/or databases in a multi-cloud environment. By understanding the relationships between such components, observability may offer actionable insights into the health of the environment and/or detect bugs or vulnerable attack vectors at the first sign of abnormal performance. Observability may aid the analysis of multi-cloud environments to detect and/or resolve underlying causes of issues. In particular, as cloud-native environments have become more complex and the potential root causes for a failure or anomaly have become more difficult to pinpoint, observability has become more critical in recent years.

According to aspects described herein, additional logic may be built into the wrapper to allow for improved application monitoring and observability. In particular, the additional logic may enable local analysis of logs captured by the wrapper to provide additional insights on application performance in the multi-cloud environment. For example, application level metrics may be collected from analyzing the logs collected by the wrapper to better understand application performance. Further, in certain aspects, these metrics may be used to dynamically determine failure thresholds for monitoring and alerting.

In other words, the additional logic built into the wrapper may allow for analytics to be performed on the logs at the point of ingestion (e.g., localized analysis), and prior to further analytics being performed at an external log analytics platform. Such localized analysis may help to minimize an amount of data that is put into a log file, and in some cases, focus on points of error, points of success, utilization metrics, runtime behaviors, step details, and/or the like present in the data prior to external transmission of the log file for further analysis. Accordingly, an amount of data that is logged may be minimized to better focus the data for analysis. Minimizing an amount of logged data for external analysis may increase computational efficiency of the system.

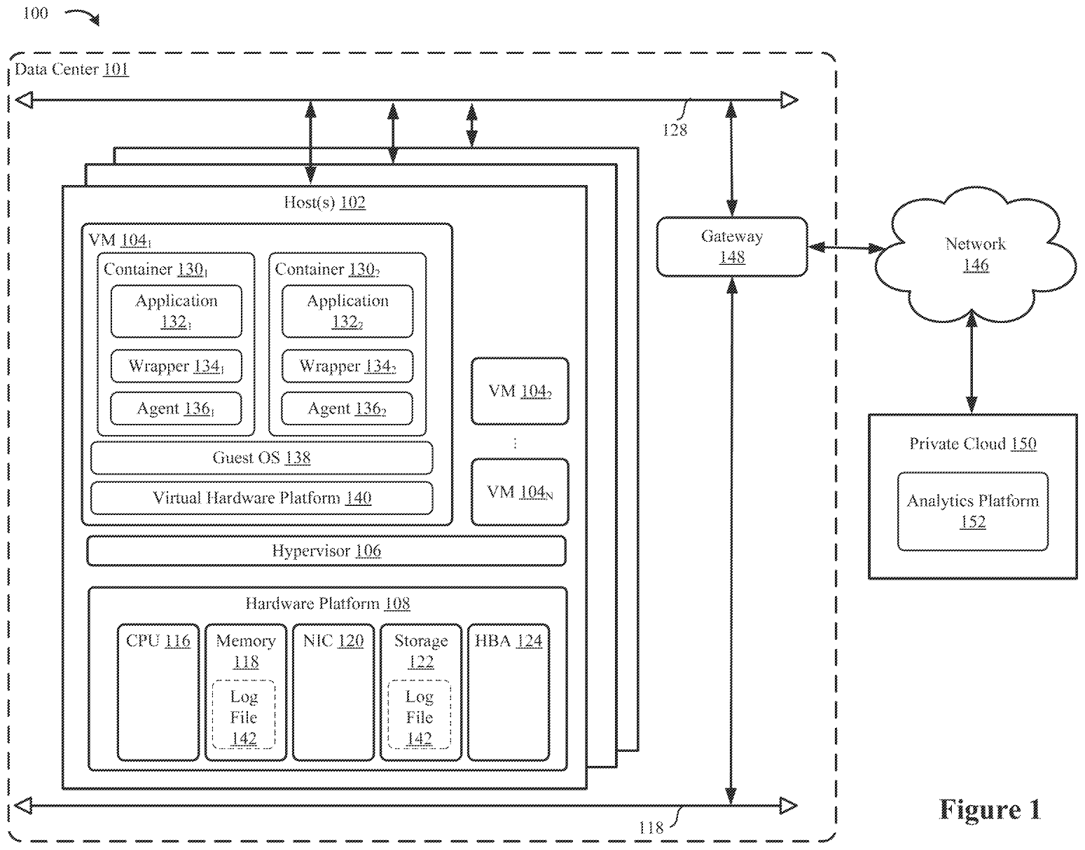

FIG. 1 depicts example physical and virtual network components in a networking environment 100 in which embodiments of the present disclosure may be implemented. As shown in FIG. 1, networking environment 100 may be distributed across a hybrid cloud (e.g., a multi-cloud environment). A hybrid cloud is a type of cloud computing that combines on-premises infrastructure, e.g., a private cloud 150 comprising one or more physical computing devices (e.g., running one or more virtual computing instances (VCIs)) on which the processes shown run, with a public cloud, or data center 101, comprising one or more physical computing devices (e.g., running one or more virtual computing instances (VCIs)) on which the processes shown run. Hybrid clouds allow data and applications to move between the two environments. Many organizations choose a hybrid cloud approach due to organization imperatives such as meeting regulatory and data sovereignty requirements, taking full advantage of on-premises technology investment, or addressing low latency issues.

Data center 101 and private cloud 150 may communicate via a network 146. Network 146 may be an external network. Network 146 may be a layer 3 (L3) physical network. Network 146 may be a public network, a wide area network (WAN) such as the Internet, a direct link, a local area network (LAN), another type of network, or a combination of these.

Private cloud 150 includes an analytics platform 152. Analytics platform 152 may include one or more services and/or technologies configured to perform analysis on voluminous, complex, and dynamic data. In certain aspects, analytics platform 152 may provide functionality for the discovery, interpretation, and/or communication of meaningful patterns in data. In particular, analytics platform 152 may analyze raw data from one or multiple sources for insights and trends. In certain aspects, analytics platform 152 is a log analytics platform configured to identify trends, analyze patterns, and provide various insights by analyzing logs from one or multiple applications 132 in data center 101. Applications 132 and their respective logs are described in more detail below. Example analytics platforms 152 may include VMware Log-Insight™ provided as part of the VMware vRealize® solution made commercially available from VMware, Inc. of Palo Alto, California and/or Logstash made commercially available by Eleastic search Inc.

Data center 101 includes one or more hosts 102 configured to provide a virtualization layer, also referred to as a hypervisor 106, that abstracts processor, memory, storage, and networking resources of hardware platform 108 into multiple VMs 1041 to 104N (collectively referred to as VMs 104 and individually referred to as VM 104) that run concurrently on the same host 102. Hypervisor 106 may run on top of an OS in host 102. In some embodiments, hypervisor 106 can be installed as system level software directly on hardware platform 108 of host 102 (often referred to as “bare metal” installation) and be conceptually interposed between the physical hardware and the guest OSs executing in VMs 104.

Each VM 104 implements a virtual hardware platform 140 that supports the installation of a guest OS 138 which is capable of executing one or more applications. Guest OS 138 may be a standard, commodity operating system. Examples of a guest OS include Microsoft Windows, Linux, and the like.

In certain embodiments, each VM 104 includes a process that enables the deployment and management of virtual instances (referred to interchangeably herein as “containers”) by providing a layer of OS-level virtualization on guest OS 138 within VM 104. Containers 130₁ to 130_{Y} (collectively referred to as containers 130 and individually referred to as container 130) are software instances that enable virtualization at the OS level. That is, with containerization, the kernel of an OS that manages host 102 is configured to provide multiple isolated user space instances, referred to as containers. Containers 130 appear as unique servers from the standpoint of an end user that communicates with each of containers 130. However, from the standpoint of the OS that manages host 102 on which the containers execute, the containers are user processes that are scheduled and dispatched by the OS.

Containers 130 encapsulate an application, such as application 132 (shown in FIG. 1 as application 132₁in container 130₁and application 132₂ in container 130₂) as a single executable package of software that bundles application code together with all of the related configuration files, libraries, and dependencies required for it to run. Bins/libraries and other runtime components are developed or executed separately for each container 130.

In certain aspects, each container 130 comprises a wrapper 134 (shown in FIG. 1 as wrapper 134₁in container 130₁and wrapper 134₂ in container 130₂). Wrapper 134 may be a wrapper or script which is implemented to call another function. In certain aspects, wrapper 134 may be implemented to call application(s) 132 for execution. Further, wrapper 134 may capture logs generated based on running application(s) 132. Wrapper 134 may capture such logs and write them to a log file 142 in memory 118 and/or storage 122. Log file 142 may be a data file that contains logs, which include descriptions of events that have occurred for application(s) 132. As described in more detail below, in certain aspects, wrapper 134 may control which logs, or an amount of logs, may be written to log file 142.

In certain aspects, each container 130 further comprises an agent 136 (shown in FIG. 1 as agent 136₁in container 130₁and agent 136₂ in container 130₂). Agent 136 may be an ingestion agent which is responsible for collecting logs written in log file 142 and forwarding these logs to an analytics platform 152 for analysis. Example agents 136 may include Fluentbit and/or Fluentd. Fluentbit and Fludentd are log processors and forwarders configured to collect data and logs from different applications 132, unify the logs, and transmit the logs to one or multiple destinations, including in certain aspects, analytics platform 152. As mentioned herein, use of wrapper 134 and agent 136 allows for the decoupling of log management logic from application 132 logic.

Hardware platform 108 of each host 102 includes components of a computing device such as one or more processors (central processing units (CPUs)) 116, memory 118, a network interface card including one or more network adapters, also referred to as NICs 120, storage 122, HBA 124, and other I/O devices such as, for example, a mouse and keyboard (not shown). CPU 116 is configured to execute instructions, for example, executable instructions that perform one or more operations described herein and that may be stored in memory 118 and in storage 122.

Memory 118 is hardware allowing information, such as executable instructions, configurations, and other data, to be stored and retrieved. Memory 118 is where programs and data are kept when CPU 116 is actively using them. Memory 118 may be volatile memory or non-volatile memory. Volatile or non-persistent memory is memory that needs constant power in order to prevent data from being erased. Volatile memory describes conventional memory, such as dynamic random access memory (DRAM). Non-volatile memory is memory that is persistent (non-volatile). Non-volatile memory is memory that retains its data after having power cycled (turned off and then back on). Non-volatile memory is byte-addressable, random access non-volatile memory.

NIC 120 enables host 102 to communicate with other devices via a communication medium. HBA 124 couples host 102 to one or more external storages (not shown), such as a storage area network (SAN). Other external storages that may be used include network-attached storage (NAS) and other network data storage systems, which may be accessible via NIC 120.

Storage 122 represents persistent storage devices (e.g., one or more hard disks, flash memory modules, solid state drives (SSDs), and/or optical disks). Although the example embodiment shown in FIG. 1 illustrates storage 122 as local storage in hardware platform 108, in some other embodiments, storage 122 is storage directly coupled to host 102. In some other embodiments, storage 122 is a virtual storage area network (VSAN) that aggregates local or direct-attached capacity devices of a host cluster, including host 102, and creates a single storage pool shared across all hosts in the cluster.

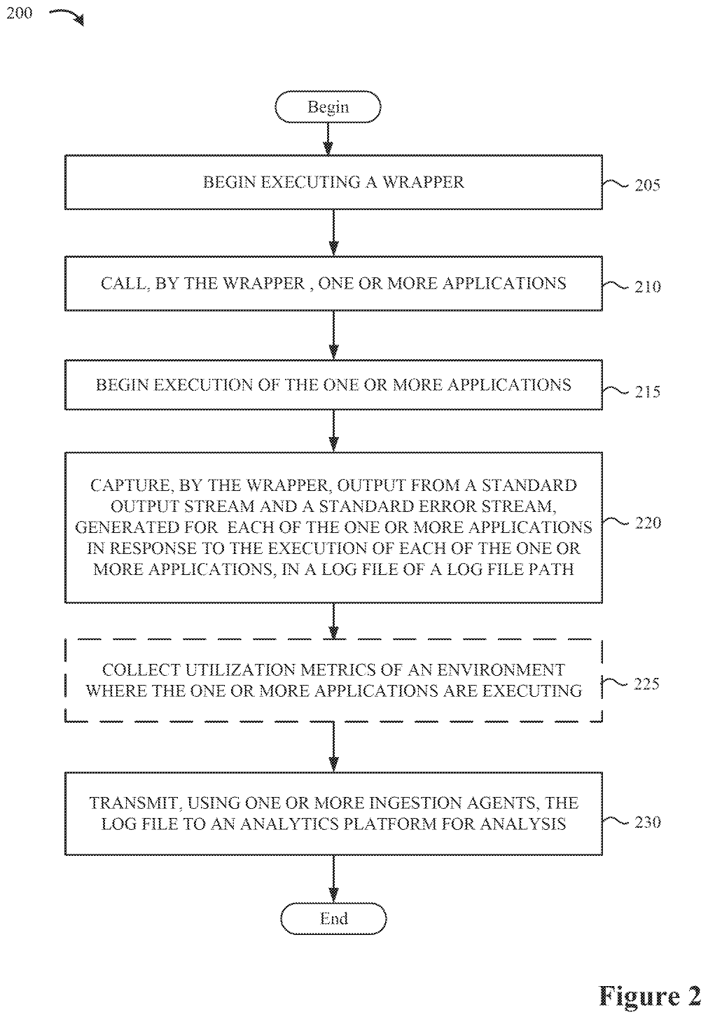

FIG. 2 is a flow diagram illustrating example operations 200 for capturing application logs using a single runtime entry-point, according to an example embodiment of the present disclosure. As shown, operations 200 illustrated in FIG. 2 may be performed by wrapper 134 and agent 136 illustrated in FIG. 1 to collect and transmit logs from one or more applications 132 to analytics platform 152 for analysis.

Operations 200 begin at operation 205 by running wrapper 134. Scripts and/or instructions for one or more applications 132 running in containers 130 in data center 101 may be scheduled through wrapper 134. Accordingly, execution of wrapper 134 causes wrapper 134 to call, at operation 210, the one or more applications 132. Calling the one or more applications 132 may invoke execution of the one or more applications 132, at operation 215. Execution of the one or more applications 132 may involve reading and acting on the instructions associated with each of the one or more applications 132. Output from executing such instructions may be produced in a stdout stream and a stderr stream for each of the one or more applications 132.

At operation 220, wrapper 134 captures output from a stdout stream and a stderr stream generated for each of the one or more applications 132 in response to the execution of each of the one or more applications 132. Wrapper 134 may capture such output in a log file of a log file path, such as in log file 142 illustrated in FIG. 1. For example, wrapper 134 may capture outputs from stdout and stderr streams by piping the output at real-time using a 0-length input buffer pipe. In certain aspects, the log file path where logs of the one or more applications 132 are written may be local to a container 130 that is executing the corresponding application 132. Although not shown at operation 220, in some cases, wrapper 134 captures user-selected output as logs in log file 142. For example, a user may customize what output is to be captured, by the wrapper, as logs, in response to the execution of each of the one or more applications 132.

At operation 230, output collected as logs in log file 142 are transmitted to analytics platform 152 (e.g., log analytics platform such as Log-Insight or Logstash) in private cloud 150. Log file 142 may be transmitted to analytics platform 152 via agent(s) 136 (e.g., ingestion agents such as Fluentbit or Fluentd). Accordingly, log analytics and monitoring may be performed at log analytics platform 152 for the log file transmitted at operation 230.

In certain aspects, prior to transmitting log file 142 at operation 230, at operation 225, wrapper 134 may collect utilization metrics of an environment where the one or more applications 132 are executing. The utilization metrics may include, for example, current system memory, disk utilization rates, network utilization rates, CPU utilization rates, and/or the like. Although operation 225 is shown subsequent to operation 220 in FIG. 2, in some cases, operation 225 and operation 220 may be performed concurrently, such that wrapper 134 is collecting logs for the one or more applications 132 and utilization metrics at the same time. Wrapper 134 may embed the collected utilization information in log file 142 thereby creating a correlation between the logs and utilization metrics within the environment. Log file 142 including both the logs and utilization metrics may be transmitted, at operation 230, to analytics platform 152 for further analysis. The addition of the utilization metrics in log file 142, and their correlation to different logs in log file 142, may improve analysis performed at analytics platform 152. In particular, the correlation may help to better understand how an application 132 is using hardware resources at different points during execution of application 132 and/or during the lifecycle of application 132.

In certain aspects, additional logic may be built into wrapper 134 to allow for application monitoring and observability. In particular, the additional logic may enable local (e.g., as opposed to at an analytics platform 152) analysis of logs captured by wrapper 134 to provide additional insights on application performance during execution. For example, application level metrics may be collected by analyzing output in logs collected by wrapper 134 for an application 132 to better understand application 132's performance. Further, in certain aspects, analysis of the logs may be used to automatically determine failure and/or degraded performance thresholds for monitoring and alerting, when necessary.

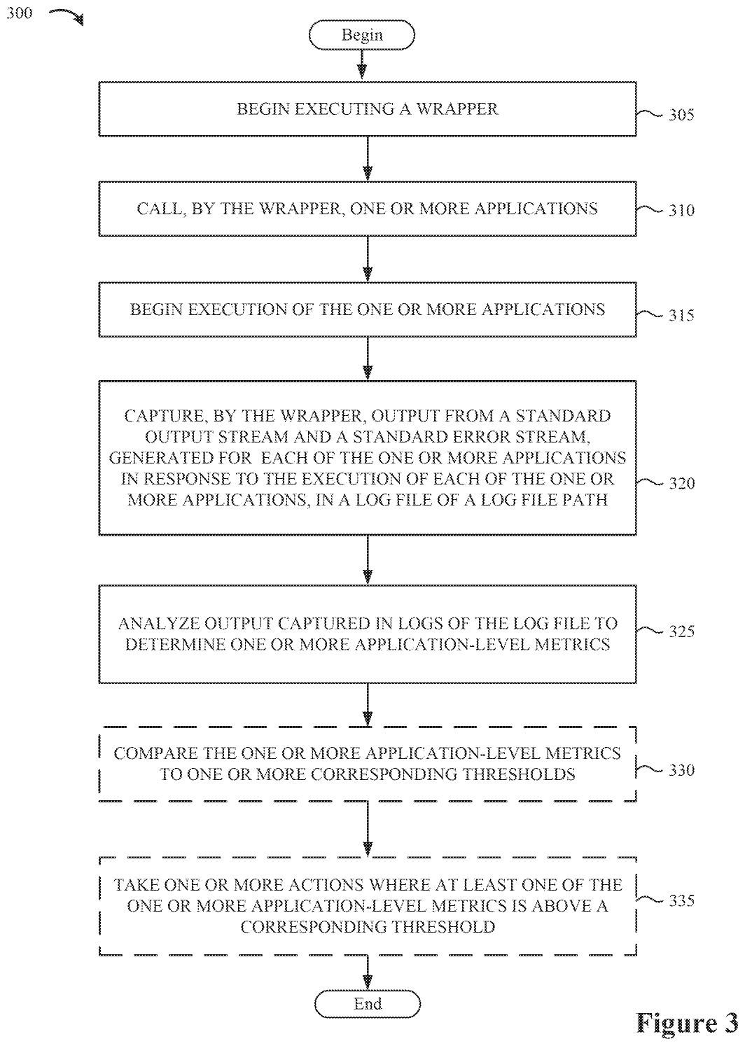

FIG. 3 is a flow diagram illustrating example operations 300 for local log analytics, monitoring, and alerting, according to an example embodiment of the present disclosure. As shown, operations 300 illustrated in FIG. 3 may be performed by wrapper 134 illustrated in FIG. 1 to collect and analyze logs from one or more applications 132 for application monitoring and observability.

Similar to operation 205 illustrated in FIG. 2, operations 300 begin at operation 305 by executing wrapper 134. Further, similar to operation operations 210-220 illustrated in FIG. 2, at operations 310-320 illustrated in FIG. 3, wrapper 134 calls one or more application 132, execution of the one or more application 132 begins, and output from a stdout stream and a stderr stream generated for each of the one or more applications 132 in response to the execution of each of the one or more applications 132 is captured in a log file 142.

However, unlike FIG. 2 which transmits the generated log file to an external analytics platform for analysis, at operation 325, additional logic configured for wrapper 134 may enable the analysis of logs captured by wrapper 134. In particular, at operation 325, output captured in logs of log file 142 may be analyzed to determine one or more application-level metrics. Examples of such application-level metrics may include script execution time, application programming interface (API) success hit rates, API failure hit rates, anomalies from normal execution, and/or the like. In certain aspects, regular expression (Regex) rules may be configured in wrapper 134 to calculate such metrics. The regex rules may use character pattern matching to find and capture application-level metrics which are desired for one or more applications 132.

In certain aspects, one or more actions may be taken based on the one or more application-level metrics determined at operation 325. For example, in certain aspects, at operation 330, the one or more application-level metrics may be compared to one or more thresholds. In certain aspects, the one or more thresholds may be automatically determined. In certain aspects, the one or more thresholds may be system thresholds which are based on previous runtime/response times. In certain aspects, the one or more thresholds are user defined. Where at least one of the application-level metrics is above one of the thresholds, at operation 335, one or more actions may be taken. In certain aspects, the one or more actions may include alerting a user.

As an illustrative example, at operation 325, API failure hit rates may be collected based on analyzing logs captured for one or more applications 132 by wrapper 134. At operation 330, the determined API failure hit rates may be compared against an API failure hit rate threshold. An API failure hit rate above an API failure hit rate threshold may indicate degraded application performance. In cases where at least one API failure hit rate is determined to be above the API failure hit rate threshold, at operation 330, a user (e.g., application developer) may be alerted regarding the degraded application performance. Any feasible method of alerting the user may be considered.

In certain aspects, additional logic may be built into wrapper 134 to allow for analytics to be performed on application logs at the point of ingestion (e.g., localized analysis), and prior to further analytics being performed at an external analytics platform. Such localized analysis may help to minimize an amount of data that is inserted into a log file, and in some cases, focus on points of error in the data prior to external transmission of the log file for such further analysis. In other words, an amount of data that is logged may be minimized to better focus the data for external analysis, which may, in turn, increase computational efficiency of the system.

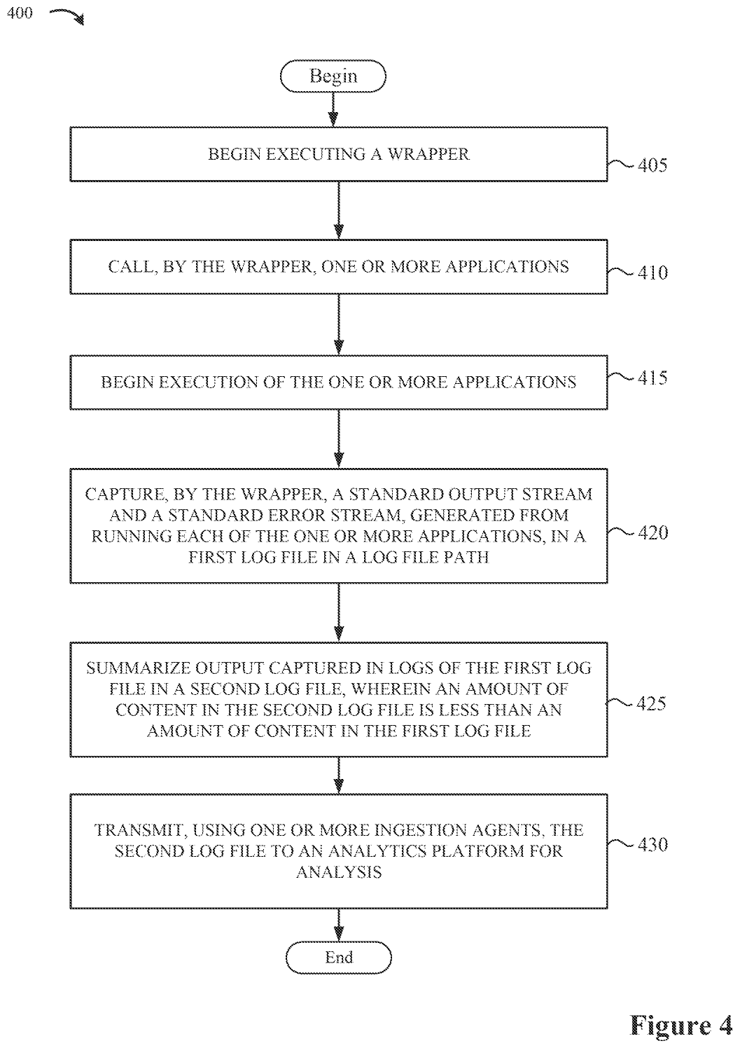

FIG. 4 is a flow diagram illustrating example operations 400 for summarizing log information prior to transmission of such information to an external log analytics platform for analysis, according to an example embodiment of the present disclosure. As shown, operations 400 illustrated in FIG. 4 may be performed by wrapper 134 illustrated in FIG. 1 to collect, analyze, and filter log information from one or more applications 132 added to log file 142, prior to transmission of log file 142 to analytics platform 152, also illustrated in FIG. 1.

Similar to operation 205 and 305 illustrated in FIG. 2 and FIG. 3, respectively, operations 400 begin at operation 405 by executing wrapper 134. Further, similar to operations 210-220 illustrated in FIGS. 2 and 310-320 illustrated in FIG. 3, at operations 410-420 illustrated in FIG. 4, wrapper 134 calls one or more applications 132, execution of the one or more applications 132 begins, and output from a stdout stream and a stderr stream generated for each of the one or more applications 132 in response to the execution of each of the one or more applications 132 is captured in a log file 142 (e.g., a first log file 142₁).

At operation 425, output captured in logs of first log file 142₁may be analyzed and summarized in a second log file 142₂. In certain aspects, summarizing the output of the first log file 142₁ in the second log file 142₂ may include removing redundant and/or unnecessary information in first log file 142₁. In certain aspects, summarizing the output of the first log file 142₁ in the second log file 142₂ may include identifying an area of interest in first log file 142₁. Areas of interest may include points of error, points of success, utilization metrics, runtime behaviors, step details, and/or the like present in first log file 142₁.

For example, in some cases, 1,000 lines of log from an application 132 may be captured in a first log file 142₁; however, only two lines of that 1,000 lines of log may be related to a failure which occurred at application 132. Accordingly, by analyzing output in the 1,000 lines of log captured in first log file 142₁, these two lines of log associated with the failure may be identified. The two lines of log may be added to a second log file 142₂, without adding the remaining 998 lines of log from the first log file 142₁.

At operation 430, second log file 142₂ is transmitted to analytics platform 152 (e.g., log analytics platform such as Log-Insight or Logstash) in private cloud 150. Second log file 142₂ may be transmitted to analytics platform 152 via agent(s) 136 (e.g., ingestion agents such as Fluentbit or Fluentd). Accordingly, log analytics and monitoring may be performed at log analytics platform 152 for the second log file 142₂ transmitted at operation 430.

Using the previous example, at operation 430, second log file 142₂ including the two lines of log is transmitted to analytics platform 152 for further analysis, as opposed to transmitting first log file 142₁ including the 1,000 lines of log to analytics platform 152 for further analysis. Accordingly, analytics performed on the log file prior to transmittal to analytics platform 152 may help to minimize an amount of logging by focusing on portions of data which are important for analysis. As a result, the size of the log file may be reduced (e.g., reducing an amount of data that is logged) thereby reducing signaling overhead when transmitting to log analytics platform 152, as well as increasing computational efficiency at log analytics platform 152 given fewer lines of data need to be analyzed to pinpoint the failure and/or its cause.

Though FIGS. 2, 3, and 4 are illustrated as different embodiments, operations performed in each of FIGS. 2, 3, and 4 may be combined. For example, logs captured for one or more application 132 may be summarized in a log file prior to transmittal of the log file to log analytics platform 152, according to operations 400 of FIG. 4, and wrapper 134 may collect and embed utilization metrics in the log file transmitted to log analytics platform 152, according to operations 200 of FIG. 2.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) --CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of analyzing logs generated by one or more applications developed based on different programming languages and frameworks, the method comprising:
calling, by a wrapper script, the one or more applications for execution;
capturing, by the wrapper script, output from the one or more applications as logs in a first log file; and
analyzing, by the wrapper script, the logs to determine one or more actions to take.

2. The method of claim 1, wherein analyzing, by the wrapper script, the logs to determine the one or more actions to take comprises:
analyzing the logs to determine one or more application-level metrics; and
comparing the one or more application-level metrics to one more corresponding thresholds.

3. The method of claim 2, wherein:
at least one of the one or more application-level metrics satisfies a corresponding threshold; and
the method further comprises alerting a user.

4. The method of claim 1, wherein analyzing, by the wrapper script, the logs to determine the one or more actions to take comprises:
summarizing the logs captured in the first log file in a second log file, wherein an amount of content in the second log file is less than an amount of content in the first log file.

5. The method of claim 4, further comprising:
transmitting the second log file to an analytics platform for further analysis.

6. The method of claim 4, wherein summarizing the logs captured in the first log file in a second log file comprises:
identifying one or more logs among the logs in the first log file identifying an error occurring with respect to at least one of the one or more applications; and
including the one or more logs in the second log file, without including the remaining logs of the first log file in the second log file.

7. The method of claim 1, further comprising:
collecting utilization metrics of an environment where the one or more applications are executing; and
embedding the utilization metrics in the first log file to create a correlation between the logs and the utilization metrics.

8. The method of claim 1, wherein the output from the one or more applications comprises at least one of:
output produced in standard out (stdout) streams for each of the one or more applications,
output produced in standard error (stderr) streams for each of the one or more applications, or
user-selected output for each of the one or more applications.

9. A system comprising:
one or more processors; and
at least one memory, the one or more processors and the at least one memory configured to cause the system to:
call, by a wrapper script, one or more applications developed based on different programming languages and frameworks for execution;
capture, by the wrapper script, output from the one or more applications as logs in a first log file; and
analyze, by the wrapper script, the logs to determine one or more actions to take.

10. The system of claim 9, wherein the one or more processors and the at least one memory are configured to cause the system to analyze, by the wrapper script, the logs to determine the one or more actions to take by:
analyzing the logs to determine one or more application-level metrics; and
comparing the one or more application-level metrics to one more corresponding thresholds.

11. The system of claim 10, wherein:
at least one of the one or more application-level metrics satisfies a corresponding threshold; and
the one or more processors and the at least one memory are further configured to cause the system to alert a user.

12. The system of claim 9, wherein the one or more processors and the at least one memory are configured to cause the system to analyze, by the wrapper script, the logs to determine the one or more actions to take by:
summarizing the logs captured in the first log file in a second log file, wherein an amount of content in the second log file is less than an amount of content in the first log file.

13. The system of claim 12, wherein the one or more processors and the at least one memory are further configured to cause the system to:
transmit the second log file to an analytics platform for further analysis.

14. The system of claim 12, wherein the one or more processors and the at least one memory are configured to cause the system to summarize the logs captured in the first log file in a second log file by:
identifying one or more logs among the logs in the first log file identifying an error occurring with respect to at least one of the one or more applications; and
including the one or more logs in the second log file, without including the remaining logs of the first log file in the second log file.

15. The system of claim 9, wherein the one or more processors and the at least one memory are further configured to cause the system to:
collect utilization metrics of an environment where the one or more applications are executing; and
embed the utilization metrics in the first log file to create a correlation between the logs and the utilization metrics.

16. The system of claim 9, wherein the output from the one or more applications comprises at least one of:
output produced in standard out (stdout) streams for each of the one or more applications,
output produced in standard error (stderr) streams for each of the one or more applications, or
user-selected output for each of the one or more applications.

17. A non-transitory computer-readable medium comprising instructions that, when executed by one or more processors of a computing system, cause the computing system to perform operations for analyzing logs generated by one or more applications developed based on different programming languages and frameworks, the operations comprising:
calling, by a wrapper script, the one or more applications for execution;
capturing, by the wrapper script, output from the one or more applications as logs in a first log file; and
analyzing, by the wrapper script, the logs to determine one or more actions to take.

18. The non-transitory computer-readable medium of claim 17, wherein analyzing, by the wrapper script, the logs to determine the one or more actions to take comprises:
analyzing the logs to determine one or more application-level metrics; and
comparing the one or more application-level metrics to one more corresponding thresholds.

19. The non-transitory computer-readable medium of claim 18, wherein:
at least one of the one or more application-level metrics satisfies a corresponding threshold; and
the operations further comprise alerting a user.

20. The non-transitory computer-readable medium of claim 17, wherein analyzing, by the wrapper script, the logs to determine the one or more actions to take comprises:
summarizing the logs captured in the first log file in a second log file, wherein an amount of content in the second log file is less than an amount of content in the first log file.
